(19) United States
(12) Patent Application Publication
(10) Pub. No.: US 2016/0338405 A1
(43) Pub. Date: Nov. 24, 2016

(54) ATOMIZING ASSEMBLY AND ELECTRONIC CIGARETTE

(71) Applicant: Qiuming Liu, Shenzhen (CN)

(72) Inventor: Qiuming Liu, Shenzhen (CN)

(21) Appl. No.: 14/356,405

(22) PCT Filed: Feb. 20, 2014
(86) PCT No.: PCT/CN2014/072321

§ 371 Date: May 6, 2014

(30) Foreign Application Priority Data
Feb. 12, 2014 (CN) 201420063667.1

(51) Int. Cl. A24F 47/00; H01R 4/28

(52) U.S. Cl. CPC A24F 47/008; H01R 4/28

(57) ABSTRACT

An atomizing assembly and an electronic cigarette are provided. The atomizing assembly includes: an atomizer, and a tar container connecting to the atomizer and adapted to store tar, wherein a fume exhausting hole adapted to exhaust fumes is provided at an end of the atomizer away from the tar container; the atomizer includes an inner electrode, and outer electrode, an electric heating wire assembly adapted to atomize the tar, a tar conveyer adapted to convey the tar to the electric heating wire assembly for atomization, and a connection section adapted to connect the atomizer with a battery rod assembly of the electronic cigarette; where the outer electrode is provided outside the inner electrode; and the electronic heating wire assembly is connected with the inner electrode and the outer electrode.

The present application is a National Stage application of PCT international application PCT/CN2014/072321, filed on Feb. 20, 2014 which claims the priority to Chinese Patent Application No. 201420063667.1 titled “ATOMIZING ASSEMBLY AND ELECTRONIC CIGARETTE”, filed with the Chinese State Intellectual Property Office on Feb. 12, 2014, both of which are incorporated by reference in their entireties.

### FIELD

The present application relates to the technical field of electronic cigarette, and particularly to an atomizing assembly and an electronic cigarette.

### BACKGROUND

A conventional structure of an electronic cigarette is shown in FIG. 7. As shown in FIG. 7, the conventional electronic cigarette includes an atomizing assembly 110 and a battery rod assembly 120 connecting to the atomizing assembly 110. An end of the atomizing assembly 110 away from the battery rod assembly 120 functions as a fume suction end 100, by which a user sucks out fumes. Further referring to FIG. 1, the atomizing assembly 110 is provided with a tar storage device 111 adapted to store liquid, a tar storage cotton 112 arranged inside the tar storage device 111, and an electric heating wire assembly 113 adapted to atomize the liquid. A fume passage is formed inside the electronic cigarette, by which the user may suck out fumes atomized by the electric heating wire assembly 113.

In the electronic cigarette as shown in FIG. 7, since the tar storage device 111 is arranged close to the fume suction end 100 and is provided inside the fume passage, the liquid in the tar storage device 111 is easy to be leaked into the fume passage, and resulting in a suction of un-atomized liquid by the user.

### SUMMARY

In view of this, an atomizing assembly and an electronic cigarette are provided in the disclosure.

An atomizing assembly includes an atomizer, and a tar container connecting to the atomizer and adapted to store tar, wherein a fume exhausting hole is provided at one end of the atomizer away from the tar container and adapted to exhaust fumes;

the atomizer includes an inner electrode, an outer electrode, an electric heating wire assembly adapted to atomize the tar, a tar conveyer adapted to convey the tar to the electric heating wire assembly for atomization, and a connection section adapted to connect with a battery rod assembly of the electronic cigarette;

the outer electrode is arranged outside the inner electrode; and

the electric heating wire assembly is electrically connected with the inner electrode and the outer electrode.

In the atomizing assembly, the atomizer includes:

an atomizer holder;

wherein the connection section is provided at a top of the atomizing holder, and the inner electrode and the outer electrode are fixed inside the connection section and electrically connected with the electric heating wire assembly;

an atomizing sleeve provided on the atomizer holder, wherein the tar conveyer is arranged inside the atomizing sleeve.

In the atomizing assembly, the connection section is a thread section adapted to connect the atomizer to the battery rod assembly through threads; or,

the connection section is a first clamping buckle adapted to connect with a first clamping groove arranged on the battery rod assembly.

In the atomizing assembly, the connection section includes:

a docking groove, wherein a second clamping buckle arranged on the battery rod assembly is rotated into the docking groove to connect with the docking groove;

a guide groove provided on a side wall of the docking groove and extending along a radial direction of the atomizing assembly, wherein the guide groove is adapted to guide the second clamping buckle;

a second clamping groove provided on the side wall of the docking groove and arranged on both sides of the guide groove, wherein the second clamping groove is adapted to connect with the second clamping buckle, and the second clamping groove is communicated with the guide groove.

In the atomizing assembly, the first clamping buckle is an elastic clamping buckle.

In the atomizing assembly,

an elastic unit is provided inside the outer electrode; and

the second clamping buckle is provided on the elastic unit and passes through the outer electrode to reach an outer surface of the atomizing assembly.

In the atomizing assembly,

the elastic unit is an elastic metal sheet or an annular metal wire.

In the atomizing assembly, an elastic positioning unit adapted to limit a position of the second clamping buckle is provided on the second clamping groove.

In the atomizing assembly, a position limiting groove adapted to contain the clamping buckle is provided at a middle portion of the elastic positioning unit.

An electronic cigarette, including:

a body of the electronic cigarette; wherein

the body of the electronic cigarette includes a fume suction end, an atomizing assembly according to any item illustrated above, and a battery rod assembly adapted to supply power to the atomizing assembly.

In the electronic cigarette, the atomizing assembly is arranged at an end of the body of the electronic cigarette away from the fume suction end; and

the fume suction end is positioned outside an end of the battery rod assembly, or the fume suction end is positioned at a middle portion of the battery rod assembly, or the fume suction end is positioned at a portion of the battery rod assembly away from the atomizing assembly.

The atomizing assembly according to the disclosure includes: an atomizer, and a tar container connecting to the atomizer and adapted to store tar, wherein a fume exhausting hole is provided at one end of the atomizer away from the tar container and adapted to exhaust fumes. The atomizer includes an inner electrode, an outer electrode, an electric hearing wire assembly adapted to atomize the tar, a tar conveyer adapted to convey the tar to the electric heating wire assembly for atomization, and a connection section adapted to connect with the battery rod assembly of the electronic cigarette. The outer electrode is provided outside the inner electrode. The electric heating wire assembly is connected with the inner electrode and the outer electrode. In the disclosure, the atomizing assembly is connected to the tar container, and one end of the atomizing assembly away from the tar container is provided with a fume exhausting hole adapted to exhaust fumes, and thus the electronic cigarette with the atomizing assembly according to the disclosure may effectively avoid a suction of un-atomized liquid by a user.

### BRIEF DESCRIPTION OF THE DRAWINGS

In order to more clearly illustrate the embodiments in the disclosure or the technical solution in the prior art, drawings referred to describe the embodiments or the prior art will be briefly described hereinafter. Apparently, the drawings in the following description are only several embodiments of the present application, and for those skilled in the art, other drawings may be obtained based on these drawings without any creative work.

FIG. 1 is a sectional structural view of an atomizing assembly according to a preferable embodiment of the disclosure;

FIG. 2 is a structural view of an atomizing assembly according to another preferable embodiment of the disclosure;

FIG. 3 is a sectional structural view of an atomizing assembly according to another preferable embodiment of the disclosure;

FIG. 4 is a structural view of an elastic unit of an atomizing assembly according to another preferable embodiment of the disclosure;

FIG. 5 is a structural view of an atomizing assembly according to another preferable embodiment of the disclosure;

FIG. 6 is an overall structural view of an electronic cigarette according to a preferable embodiment of the disclosure; and

FIG. 7 is a sectional structural view of an electronic cigarette according to the existing technology.

### DETAILED DESCRIPTION OF EMBODIMENTS

An atomizing assembly is provided according to the disclosure.

The atomizing assembly includes:

an atomizer 100, and a tar container 101 connecting to the atomizer and adapted to store tar, wherein a fume exhausting hole (not indicated by a number in FIG. 1) is provided at one end of the atomizer 100 away from the tar container 101 and adapted to exhaust fumes.

The atomizer 100 includes an inner electrode 102, an outer electrode 103, an electric heating wire assembly 104 adapted to atomize the tar, a tar conveyer 105 adapted to convey the tar to the electric heating wire assembly for atomization, and a connection section 106 adapted to connect with a battery rod assembly of the electronic cigarette.

The outer electrode 103 is provided outside the inner electrode 102.

The electric heating wire assembly 104 is electronically connected with the inner electrode 102 and the outer electrode 103.

The atomizing assembly according to the embodiment is adapted to atomize the tar. One end of the atomizer 100 is connected to the tar container 101, and the other end of the atomizer 100 is connected with the battery rod assembly in a removable manner. In an embodiment, one end of the atomizer 100 is integrated with the tar container 101 irremovably. In this way, only the battery rod assembly is removable in case of an external force upon the electronic cigarette, therefore effectively avoiding a mis-operation. In another embodiment, one end of the atomizer 100 is connected with the tar container 101 in a removable manner. The connection in the removable manner may be a threaded connection, a clamping buckle connection or a magnetically attraction connection, which will not be limited herein.

The specific structure of the atomizing assembly is further illustrated in detailed in conjunction with FIG. 1.

The atomizer 100 includes: an atomizer holder 107 and an atomizing sleeve 108 provided on the atomizer holder 107.

The connection section 106 is provided at a top of the atomizer holder 107.

The inner electrode 102 and the outer electrode 103 is fixed inside the connection section 106 and electrically connected with the electric heating wire assembly 104.

The tar conveyer 105 is arranged inside the atomizing sleeve 108.

Preferably, the tar conveyer 105 may be made by for example tar conveying cottons, or tar conveying fibers, which will not be limited herein.

More preferably, at least one tar conveying hole is provided on a surrounding wall of the atomizing sleeve 108, through which the liquid inside the tar container 101 may be smoothly conveyed to the tar conveyer 105.

The advantage of the removable connection between the atomizing assembly and the battery assembly lies in that the user may charge the battery rod assembly whenever necessary.

The removable connection between the atomizing assembly and the battery assembly may be achieved as follows.

In a first removable connection manner, the connection section 106 is a thread section.

Matching threads, matching with threads of the thread section, are provided at a part of the battery rod assembly opposite to the connection section 106.

A threaded connection between the atomizing assembly and the battery rod assembly is implemented by the thread section and the matching thread.

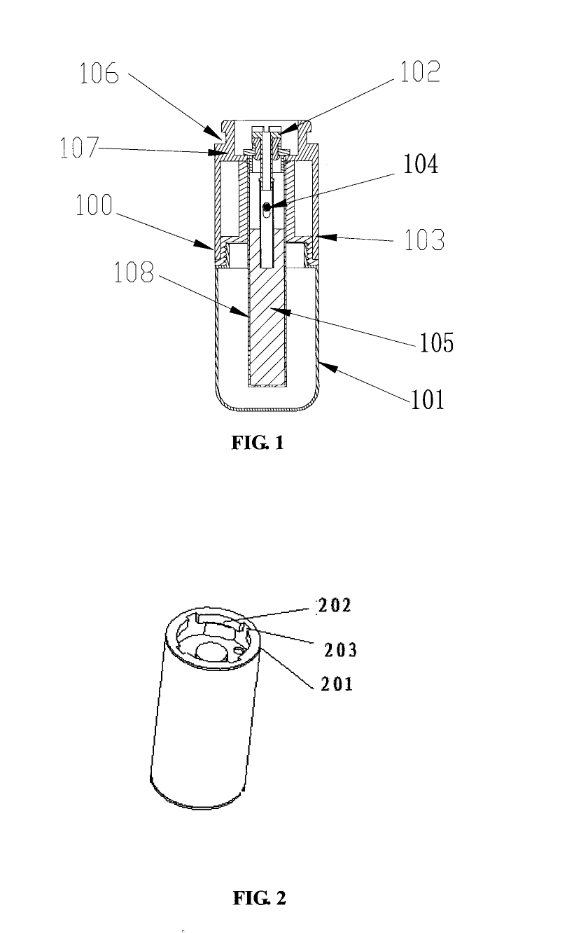

A second connection manner is illustrated in detail in conjunction with FIG. 2 as follows.

The connection section 106 is positioned at an end of the atomizing assembly connecting to the battery rod assembly, and the connection section 106 includes:

a docking groove 201, where the second clamping buckle arranged on the battery rod assembly is rotated into the docking groove to connect with the docking groove;

a guide groove 202 adapted to guide the second clamping buckle, which is provided on a side wall of the docking groove 201 and extends along a radial direction of the atomizing assembly; and

a second clamping groove 203 adapted to connect with the second clamping buckle, which is provided on a side wall of the docking groove 201 and arranged on both sides of the guide groove 202, where the second clamping groove 203 is communicated with the guide groove 202.

In order to further tightly connect the second clamping groove with the second clamping buckle, a magnetic adsorption unit adapted to adsorb the clamping buckle may be provided on the side wall of the second clamping groove.

The clamping buckle may be tightly connected to the clamping groove by the magnetic adsorption unit in the second clamping groove, so that the atomizing assembly and the battery rod assembly may be firmly fixed, or that the atomizing assembly and the tar container may be firmly fixed.

In order to further avoid a displacement of the second clamping buckle connected to the second clamping groove, such as a leftward or rightward displacement of the second clamping buckle connected to the second clamping groove, an elastic positioning unit adapted to limit the position of the clamping buckle is located on the second clamping groove.

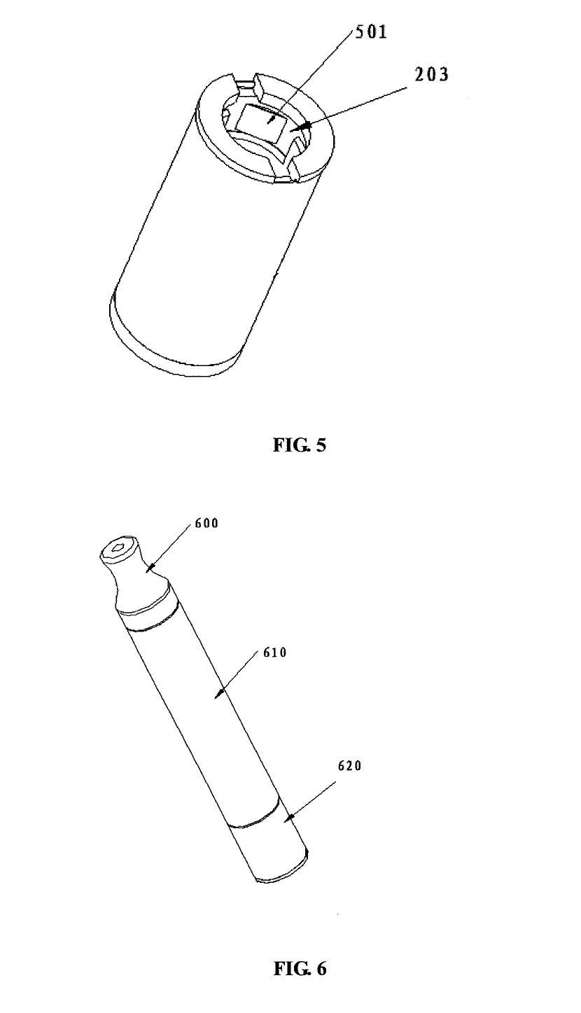

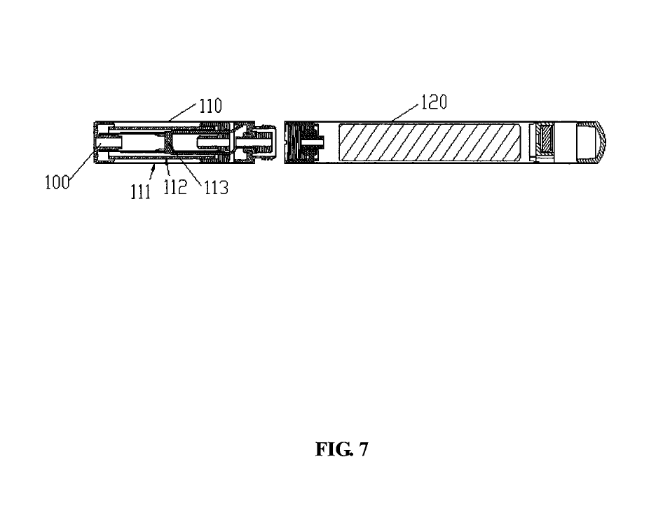

FIG. 5 shows the structure of the elastic positioning unit.

As shown in FIG. 5, an elastic positioning unit 501 adapted to limit the position of the clamping buckle is located on the second clamping groove 203 arranged at an end portion of the atomizing assembly.

With the elastic positioning unit 501, the second clamping buckle inside the second clamping groove 203 may not be displaced leftward or rightward.

Preferably, the elastic positioning unit 501 is provided at one side of the first clamping groove.

More preferably, a position limiting groove adapted to contain the clamping buckle is provided at a middle portion of the elastic positioning unit 501. With the position limiting groove, the displacement of the clamping buckle in the clamping groove may further be avoided, and the stability among all the assemblies of the electronic cigarette may be improved.

Thus, the battery rod assembly and the atomizing assembly are locked according to the structure illustrated in the second connection manner.

In a third connection manner, the connection section 106 is a first clamping buckle.

A first clamping groove is provided at a part of the battery rod assembly opposite to the connection section 106, which has the same structure with the second clamping groove as shown in FIG. 2 and will be omitted herein.

Preferably, the first clamping buckle is an elastic clamping buckle.

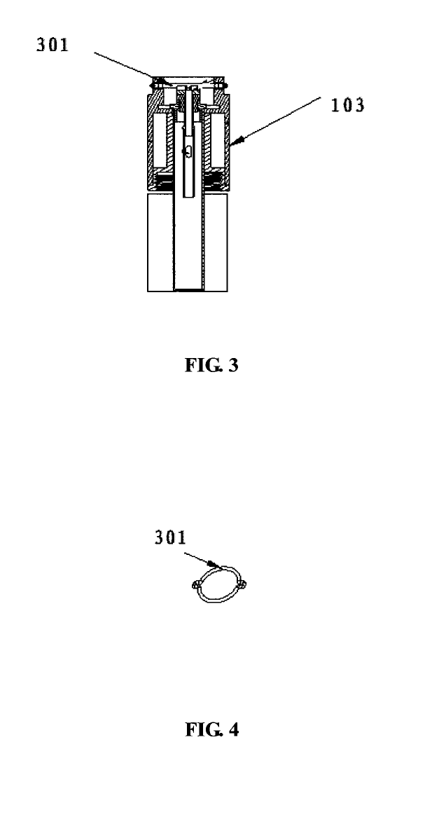

The fourth connection manner is illustrated in detail in conjunction with FIG. 3 as follows.

An elastic unit 301 is provided inside the outer electrode 103.

The second clamping buckle is provided on the elastic unit 301 and passes through the outer electrode 301 to reach an outer surface of the atomizing assembly.

The elastic unit 301 may be an elastic metal sheet or an annular metal wire.

The structure of the elastic unit 301, in case of the annular metal wire, is shown in FIG. 4.

By locking the atomizing assembly and the battery rod assembly through the second clamping buckle of the elastic unit 301, the second clamping buckle maintains its good elasticity in the locking process, the removing and installation process becomes smooth, and the atomizing assembly and the battery rod assembly are firmly locked.

This embodiment also provides an electronic cigarette, whose overall structure is shown in FIG. 6.

The electronic cigarette includes a body of the electronic cigarette. A fume suction end 600 is provided at the body of the electronic cigarette, through which the user may suck fumes.

The body of the electronic cigarette also includes a battery rod assembly 610 adapted to supply power to an atomizing assembly 620.

The structure of the atomizing assembly 620 is illustrated in the above embodiments, which will be omitted herein. A fume exhausting hole of the atomizer 100 is communicated with a fume passage inside the body of the electronic cigarette, to convey fumes in the atomizer 100 to a mouth of a smoker through the fume passage and the fume exhausting hole.

As shown in FIG. 6, the fume passage inside the body of the electronic cigarette does not go through the tar container of the atomizing assembly 620, thus avoiding a leakage of un-atomized liquid from the tar container to the fume passage, and further avoiding a suction of the un-atomized liquid by a user, and therefore effectively avoiding the leakage of the liquid. Also, a fume passage, which does not pass through the tar container, may also effectively avoid a condensation of fumes in the fume passage, which therefore effectively avoids a block of the fume passage due to the condensed liquid.

In this embodiment, in order that the overall structure of the electronic cigarette imitates a real cigarette, suits a user's smoking habits and reduces tar accumulation, the atomizing assembly 620 and the battery rod assembly 610 are coaxially arranged.

The detailed arrangement of the atomizing assembly 620 and the battery rod assembly 610 will not be limited in this embodiment. For example, the battery rod assembly 610 and the atomizing assembly 620 sequentially connected may be staggered to form the overall structure of the electronic cigarette in an irregular shape. The irregular shape may be any shape.

The atomizing assembly 620 and the battery rod assembly 610 may also be non-coaxially arranged, to form the overall structure of the electronic cigarette in a T-shape.

That is, an appearance of the electronic cigarette according to the disclosure is not limited.

The battery rod assembly according to this embodiment has a conventional inner structure, which will be omitted herein.

In an embodiment, the atomizing assembly 620 is positioned at an end of the battery rod assembly 610. The fume suction end 600 is positioned outside the other end of the battery rod assembly 610, the fume suction end 600 is positioned at the middle portion of the battery rod assembly 610, or the fume suction end 600 is positioned on a portion of the battery rod assembly 610 away from the atomizing assembly 620.

The fume suction end 600 positioned outside the other end of the battery rod assembly 610 may be arranged coaxially with the battery rod assembly 610. The appearance of the electronic cigarette may visually imitate a real cigarette by this arrangement, such that the electronic cigarette has a straight fume passage, and therefore the tar accumulation is effectively reduced.

Alternatively, the fume suction end 600 may be positioned at the middle portion of the battery rod assembly, or the fume suction end 600 may be positioned at a portion of the battery rod assembly 610 away from the atomizing assembly 620.

In the disclosure, the position of the fume suction end 600 is not limited.

The technical solution according to the embodiments of the disclosure will be described clearly and fully in conjunction with the appended drawings. Apparently, the described embodiments are not the whole but just part of the embodiments of the present invention. All the other embodiments that can be gained by those with ordinary skills in the art without creative work shall fall into the scope of protection sought for in the present invention.

The embodiments of the present invention are described herein in a progressive manner, each of which emphasizes the differences from others; hence for the same or similar parts between the embodiments, one can refer to the other embodiments.

The above description of the disclosed embodiments enables those skilled in the art to implement or use the invention. Numerous modifications to the embodiments will be apparent to those skilled in the art, and the general principle herein can be implemented in other embodiments without departing from the spirit or scope of the invention. Therefore, the present invention shall not be limited to the embodiments described herein, but shall cover the widest scope consistent with the principle and novelty features disclosed herein.

1. An atomizing assembly, comprising an atomizer, and a tar container connecting to the atomizer and adapted to store tar, wherein a fume exhausting hole is provided at an end of the atomizer away from the tar container and adapted to exhaust fumes;
the atomizer comprises an inner electrode, an outer electrode, an electric heating wire assembly adapted to atomize the tar, a tar conveyer adapted to convey the tar to the electric heating wire assembly for atomization, and a connection section adapted to connect the atomizer with a battery rod assembly of the electronic cigarette,
wherein the outer electrode is provided outside the inner electrode; and
the electric heating wire assembly is electrically connected with the inner electrode and the outer electrode.

2. The atomizing assembly according to claim 1, wherein the atomizer comprises:
an atomizer holder, wherein the connection section is provided at a top of the atomizer holder, and the inner electrode and the outer electrode are fixed inside the connection section and electrically connected with the electric heating wire assembly; and
an atomizing sleeve provided on the atomizer holder, wherein the tar conveyer is provided inside the atomizing sleeve.

3. The atomizing assembly according to claim 1, wherein the connection section is a thread section adapted to connect the atomizer to the battery rod assembly through threads; or,
the connection section is a first clamping buckle adapted to connect with a first clamping groove arranged on the battery rod assembly.

4. The atomizing assembly according to claim 1, wherein the connection section comprises:
a docking groove, wherein a second clamping buckle arranged on the battery rod assembly is rotated into the docking groove to connect with the docking groove;
a guide groove provided on a side wall of the docking groove and extending along a radial direction of the atomizing assembly, wherein the guide groove is adapted to guide the second clamping buckle; and
a second clamping groove provided on the side wall of the docking groove and arranged on both sides of the guide groove, wherein the second clamping groove is adapted to connect with the second clamping buckle and the second clamping groove is communicated with the guide groove.

5. The atomizing assembly according to claim 3, wherein the first clamping buckle is an elastic clamping buckle.

6. The atomizing assembly according to claim 4, wherein
an elastic unit is provided inside the outer electrode; and
the second clamping buckle is provided on the elastic unit and passes through the outer electrode to reach an outer surface of the atomizing assembly.

7. The atomizing assembly according to claim 6, wherein
the elastic unit is an elastic metal sheet or an annular metal wire.

8. The atomizing assembly according to claim 4, wherein an elastic poisoning unit adapted to limit a position of the second clamping buckle is provided on the second clamping groove.

9. The atomizing assembly according to claim 8, wherein a position limiting groove adapted to contain the clamping buckle is provided at a middle portion of the elastic positioning unit.

10. An electronic cigarette, comprising:
a body of the electronic cigarette;
wherein the body of the electronic cigarette includes a fume suction end, an atomizing assembly, and a battery rod assembly adapted to supply power to the atomizing assembly,
wherein the atomizing assembly comprises an atomizer, and a tar container connecting to the atomizer and adapted to store tar, a fume exhausting hole is provided at an end of the atomizer away from the tar container and adapted to exhaust fumes,
the atomizer comprises an inner electrode, an outer electrode, an electric heating wire assembly adapted to atomize the tar, a tar conveyer adapted to convey the tar to the electric heating wire assembly for atomization, and a connection section adapted to connect the atomizer with a battery rod assembly of the electronic cigarette,
the outer electrode is provided outside the inner electrode; and
the electric heating wire assembly is electrically connected with the inner electrode and the outer electrode.

11. The electronic cigarette according to claim 10, wherein the atomizing assembly is provided at an end of the body of the electronic cigarette away from the fume suction end; and
the fume suction end is positioned outside an end of the battery rod assembly, or the fume suction end is positioned at a middle portion of the battery rod assembly, or the fume suction end is positioned at a portion of the battery rod assembly away from the atomizing assembly.

12. The electronic cigarette according to claim 10, wherein the atomizer comprises:
an atomizer holder, wherein the connection section is provided at a top of the atomizer holder, and the inner electrode and the outer electrode are fixed inside the connection section and electrically connected with the electric heating wire assembly; and
an atomizing sleeve provided on the atomizer holder, wherein the tar conveyer is provided inside the atomizing sleeve.

13. The electronic cigarette according to claim 10, wherein the connection section is a thread section adapted to connect the atomizer to the battery rod assembly through threads; or,
the connection section is a first clamping buckle adapted to connect with a first clamping groove arranged on the battery rod assembly.

14. The electronic cigarette according to claim 10, wherein the connection section comprises:
a docking groove, wherein a second clamping buckle arranged on the battery rod assembly is rotated into the docking groove to connect with the docking groove;
a guide groove provided on a side wall of the docking groove and extending along a radial direction of the atomizing assembly, wherein the guide groove is adapted to guide the second clamping buckle; and
a second clamping groove provided on the side wall of the docking groove and arranged on both sides of the guide groove, wherein the second clamping groove is adapted to connect with the second clamping buckle and the second clamping groove is communicated with the guide groove.

15. The electronic cigarette according to claim 13, wherein the first clamping buckle is an elastic clamping buckle.

16. The electronic cigarette according to claim 14, wherein
an elastic unit is provided inside the outer electrode; and
the second clamping buckle is provided on the elastic unit and passes through the outer electrode to reach an outer surface of the atomizing assembly.

17. The electronic cigarette according to claim 16, wherein
the elastic unit is an elastic metal sheet or an annular metal wire.

18. The electronic cigarette according to claim 14, wherein an elastic poisoning unit adapted to limit a position of the second clamping buckle is provided on the second clamping groove.

19. The electronic cigarette according to claim 18, wherein a position limiting groove adapted to contain the clamping buckle is provided at a middle portion of the elastic positioning unit.
